(19) United States
(12) Patent Application Publication
(10) Pub. No.: US 2018/0129524 A1
(43) Pub. Date: May 10, 2018

(54) MANAGING PRE-ALLOCATED VIRTUAL MACHINE INSTANCE POOLS

(71) Applicant: International Business Machines Corporation, Armonk, NY (US)

(72) Inventors: Jay S. Bryant, Rochester, MN (US); James E. Carey, Rochester, MN (US); Kendall J. Nelson, St. Paul, MN (US); Lucas A. Palm, Rochester, MN (US)

(21) Appl. No.: 15/348,601

(22) Filed: Nov. 10, 2016

(51) Int. Cl. G06F 9/455; G06F 11/30; G06F 11/34

(52) U.S. Cl. CPC G06F 9/45558; G06F 11/3006; G06F 2009/4557; G06F 11/3433; G06F 11/301

(57) ABSTRACT

A multiple pool data set including a first definition is received. The first definition specifies a first configuration for each of a plurality of virtual machine pools. Each of the plurality of virtual machine pools includes a set of virtual machines. Each virtual machine in each set of virtual machines is characterized by a plurality of attribute values including a processing-related attribute value or a memory attribute value or both. An historic data usage set is received that includes historical usage information indicative of a manner in which the plurality of virtual machine pools has been historically utilized. A second definition is determined that specifies a second configuration for each of the pools. The second definition is based on the historical usage information, and the first definition is different from the second definition.

### FIELD

The present disclosure relates generally to virtualized computing environments. More specifically, this disclosure relates to the management of pre-allocated virtual machine instance pools.

### BACKGROUND

As the term is used in this document, a “virtual machine” is a set of computer code that emulates a computer system in a manner that: (i) is based on computer architectures of a computer (for example, a physical computer including substantial hardware), and (ii) provides functionality of a computer (for example, a physical computer including substantial hardware). Implementations of virtual machines (sometimes herein referred to as “instances” or “instantiations”) may involve specialized hardware, software or a combination of hardware and software.

Containers are similar to virtual machines but, being simply a process, containers are much quicker to start up and initialize. In some cases, use of containers may require extensive initialization. For example, creating a set of containers to work together requires configuration, setup, and validation. A pooled item would be comprised of a set of cooperating containers. In some situations, significant setup time is required, such as when a private virtual network needs to be set up in conjunction with the containers. This would mean that network resources would need to be a part of the pooling trade-off, since limited resources are involved. Thus, pooling may involve pooling a cooperative set of virtual machines, a cooperative set of container instances, or any of various combinations thereof.

Some virtual machines (VMs) include the following: (i) system virtual machines (also termed full virtualization VMs); (ii) process virtual machines designed to execute computer programs in a platform-independent environment; and (iii) VMs designed to also emulate different architectures and allow execution of software applications and operating systems written for another CPU or architecture VMs are sometimes pre-allocated into instance pools. What this means is that images for an identifiable set (called a “pool”) of virtual machines are instantiated and initialized. Then, one or more virtual machine images is started in operation and allocated to be assigned to perform computational workloads, from a single source, acting as a unit.

### SUMMARY

The following summary is merely intended to be exemplary. The summary is not intended to limit the scope of the claims.

A method, in one aspect, comprises monitoring a plurality of virtual machines that are currently operating within a cloud, to generate an input data set based on the operating of the plurality of virtual machines; analyzing, by a machine logic-based pool manager, the input data set to determine configuration data for allocating each respective virtual machine of the plurality of virtual machines to a corresponding pool of a plurality of pools; and allocating and configuring, by the pool manager, the plurality of virtual machines into the plurality of pools according to the determined configuration data. The pool manager receives a request to deploy a virtual machine of the plurality of virtual machines in the cloud, wherein the request includes a set of request parameter data. Responsive to the request, the pool manager selects a pooled virtual machine from any of the plurality of pools, wherein the pooled virtual machine meets the set of request parameter data. The pool manager deploys the pooled virtual machine to fulfill the request.

A method, in another aspect, comprises receiving a multiple pool data set, wherein the multiple pool data set includes a first definition that, for each of a respective plurality of virtual machine pools, specifies a corresponding first configuration, and wherein each of the respective plurality of virtual machine pools includes a corresponding set of virtual machines. Each virtual machine of each corresponding set of virtual machines is respectively characterized by a plurality of attribute values including at least one of a processing related attribute value, or a memory attribute value, or both a processing related attribute value and a memory attribute value. An historic data usage set is received that includes historical usage information indicative of a manner in which the plurality of virtual machine pools has been historically utilized by one or more users; determining a second definition specifying a corresponding second configuration for each of the respective plurality of virtual machine pools, wherein the second definition is based at least in part on the historical usage information, and wherein the first definition is different from the second definition. An instance of the plurality of virtual machine pools is configured according to the first definition, and the instance of the plurality of virtual machine pools is then reconfigured according to the second definition. The first definition is different from the second definition based on any of moving a virtual machine-related resource from a first virtual machine pool of the plurality of virtual machine pools to a second virtual machine pool of the plurality of virtual machine pools; adding a virtual machine pool to the plurality of virtual machine pools; removing a virtual machine pool from the plurality of virtual machine pools; adding a virtual machine related resource to a virtual machine pool of the plurality of virtual machine pools; or removing a virtual machine related resource from the plurality of virtual machine pools.

A computer program product, in another aspect, comprises a computer-readable storage medium having a computer-readable program stored therein, wherein the computer-readable program, when executed on a computing device including at least one processor, causes the at least one processor to monitor a plurality of virtual machines that are currently operating within a first cloud, generate an input data set based on the operating of the plurality of virtual machines; analyze, using a machine logic-based pool manager, the input data set to determine configuration data for allocating each respective virtual machine of the plurality of virtual machines to a corresponding pool of a plurality of pools; allocate and configure, using the pool manager, the plurality of virtual machines into the plurality of pools according to the determined configuration data; receive a request at the pool manager to deploy a virtual machine of the plurality of machines in the first cloud, wherein the request includes a set of request parameter data; responsive to the request, causing the pool manager to select a first pooled virtual machine from any of the plurality of pools, wherein the first pooled virtual machine meets the set of request parameter data; and causing the pool manager to deploy the first pooled virtual machine to fulfill the request.

### BRIEF DESCRIPTION OF THE SEVERAL VIEWS OF THE DRAWINGS

The foregoing aspects and other features are explained in the following description, taken in connection with the accompanying drawings, wherein:

FIG. 1 illustrates a first exemplary method for managing virtual machine instance pools in accordance with one or more embodiments of the present invention.

FIG. 2 illustrates a second exemplary method for managing virtual machine instance pools in accordance with one or more embodiments of the present invention.

FIG. 3 illustrates an exemplary system on which any of the methods of FIG. 1 or FIG. 2 may be performed in accordance with one or more embodiments of the present invention.

FIG. 4 illustrates an exemplary apparatus on which any of the methods of FIG. 1 or FIG. 2 may be performed in accordance with one or more embodiments of the present invention.

### DETAILED DESCRIPTION

Some embodiments of the present invention may recognize one, or more, of the following opportunities for improvement, drawbacks, design imperatives and/or problems respecting the pre-allocation of VMs into instance pools: (i) improvements in the pre-allocation of VMs into instance pools can decrease server deployment time and thereby improve a user's cloud computing experience; (ii) providing the best possible cloud experience for users; (iii) a user's cloud computing experience is influenced significantly by end-to-end virtual server deployment; (iv) some factors that influence server deployment on a cloud hosting service include: ease of use of user interface (for example, simplicity of user interface design), amount of server customization options and/or amount of time required for server deployment; (v) server customization options may include, for example, box resource size, hosting region, and image type; (vi) server deployment time is of particular interest in the cloud; (vii) deployment time can either make or break a hosting service; (viii) shorter deployment times (when creating a new server instance in a cloud provider's cloud) can attract new users and thereby increase revenue and/or profits of the cloud provider; and/or (ix) as a practical matter, it is often challenging to achieve a best-in-class deployment time.

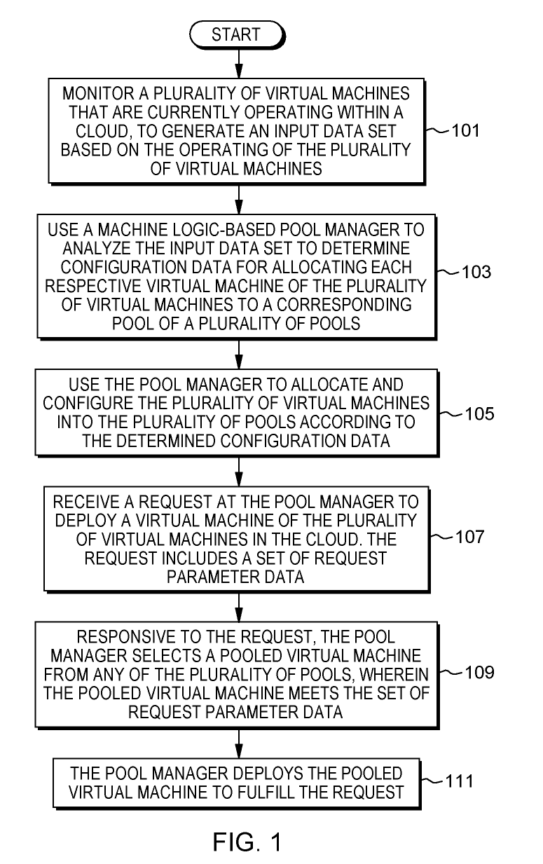

FIG. 1 illustrates a first exemplary method for managing virtual machine instance pools in accordance with one or more embodiments of the present invention. The method commences at block 101 where a plurality of virtual machines that are currently operating and in use within a cloud are monitored. The monitoring is performed to generate an input data set based on the operating of the plurality of virtual machines. Illustratively, the monitoring includes collecting any of the following types of input data: a user identifier, an image type, an identifier for a central processing unit (CPU) core, an amount of random-access memory (RAM) being used, a calendar date, a time, and a duration of initialization for each of the plurality of virtual machines.

Next, at block 103, a machine logic-based pool manager analyzes the input data set to determine configuration data for allocating each respective virtual machine of the plurality of virtual machines to a corresponding pool of a plurality of pools. The pool manager may be implemented using a dedicated pool manager node. The pool manager is in charge of watching over each of the plurality of pools, ensuring that there are a sufficient number of instances in each pool. The determination of the configuration data may be performed in such a way that the plurality of pools will have a highest or maximized probability of meeting a subsequently received set of request parameter data.

The operational sequence progresses to block 105 where the pool manager allocates and configures the plurality of virtual machines into the plurality of pools according to the determined configuration data. For example, multiple pools of virtual machines may be created at each data center region offered by a cloud service. Individual pools of the plurality of pools may be home to a specific set of instance types in terms of image type and resource size. A pool may exist for each instance type offered by the cloud service. In each pool, there may be at least one virtual machine that is pre-created and ready to be assigned, pending a request received from a user.

The operational sequence progresses to block 107 where the pool manager receives a request from a user to deploy a virtual machine of the plurality of virtual machines in the cloud. The request includes a set of request parameter data, illustratively in the form of machine specifications that are related to one or more instance types. In order to know what type of instances and how many instances are in a given pool of the plurality of pools, a look-up table may be employed. This look-up table associates each of a plurality of virtual machines with a corresponding set of instance types. The look-up table is a multi-purpose tool used by the pool manager for both determining a current stock of virtual machines in each pool, and for locating a specific virtual machine that will be deployed in response to one or more subsequently received requests that are predicted to be received from a user based upon the historical usage information.

Responsive to the request, the pool manager selects a pooled virtual machine from any of the plurality of pools (block 109), wherein the pooled virtual machine meets the set of request parameter data. The pool manager searches through the look-up table to locate an instance type that matches a set of machine specifications provided in the request, or to locate an instance type that is most similar to the set of machine specifications provided in the request. If a matching or similar instance type is located, the pool manager then deploys the pooled virtual machine to fulfill the request (block 111). A virtual machine associated with this instance type in the look-up table is identified and assigned to the user.

The assignment may be performed by attaching the virtual machine to an account associated with the user. Since this virtual machine has already been configured at block 105, no creation time is required for creating a virtual machine for the user. However, once the virtual machine is assigned to the user, another virtual machine may be created and inserted into the correct pool to replace the virtual machine that was just assigned to the user.

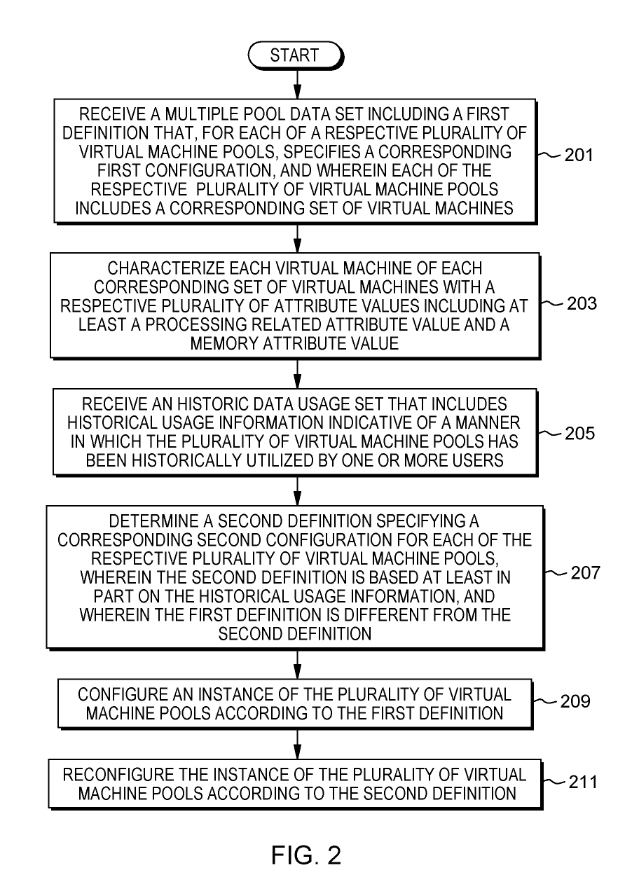

FIG. 2 illustrates a second exemplary method for managing virtual machine instance pools in accordance with one or more embodiments of the present invention. The operational sequence commences at block 201 where a multiple pool data set is received. The multiple pool data set includes a first definition that, for each of a respective plurality of virtual machine pools, specifies a corresponding first configuration. Each of the respective plurality of virtual machine pools includes a corresponding set of virtual machines.

Next, at block 203, each virtual machine of each corresponding set of virtual machines is characterized with a respective plurality of attribute values including at least a processing related attribute value and a memory attribute value. An illustrative example of a processing related attribute value is a number or quantity of processor cores, and an illustrative example of a memory attribute value is a random access memory (RAM) capacity. Then, at block 205, an historic data usage set is received that includes historical usage information indicative of a manner in which the plurality of virtual machine pools has been historically utilized by one or more users.

The procedure of FIG. 2 progresses to block 207 where a second definition is determined that specifies a corresponding second configuration for each of the respective plurality of virtual machine pools. The second definition is based at least in part on the historical usage information. The first definition is different from the second definition. Next, at block 209, an instance of the plurality of virtual machine pools is configured according to the first definition. Then, at block 211, the instance of the plurality of virtual machine pools is reconfigured according to the second definition. The difference or differences between the first definition and the second definition may reflect at least one of the following types of differences: (a) moving a virtual machine-related resource from a first virtual machine pool of the plurality of virtual machine pools to a second virtual machine pool of the plurality of virtual machine pools, (b) adding a virtual machine pool to the plurality of virtual machine pools, (c) removing a virtual machine pool from the plurality of virtual machine pools, (d) adding a virtual machine-related resource to a virtual machine pool of the plurality of virtual machine pools, and/or (e) removing a virtual machine-related resource from the plurality of virtual machine pools.

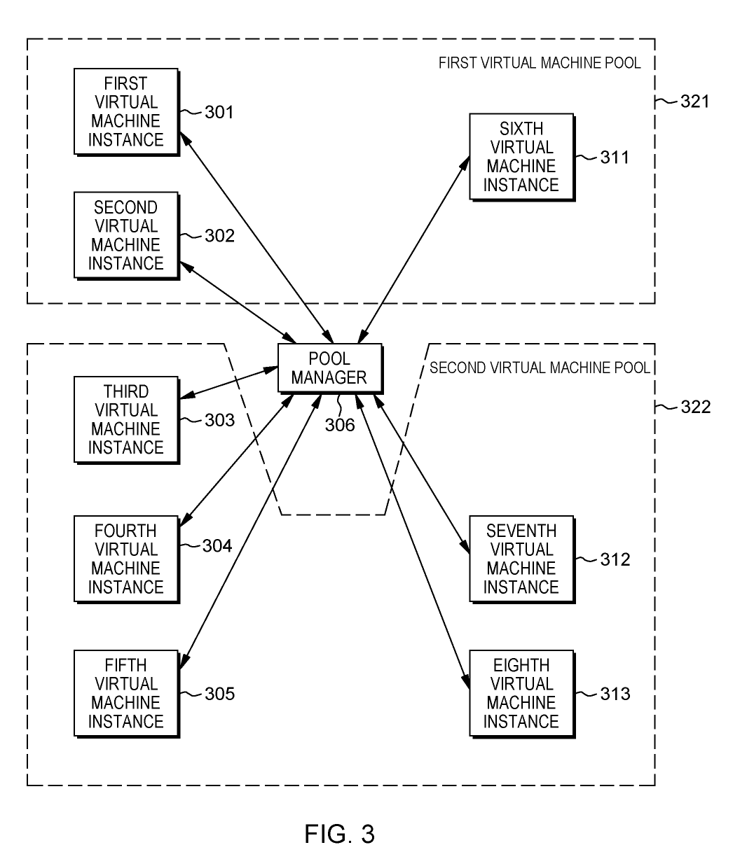

FIG. 3 illustrates an exemplary system on which any of the methods of FIG. 1 or FIG. 2 may be performed in accordance with one or more embodiments of the present invention. The methods of FIGS. 1 and 2 are used to create pools of pre-allocated virtual machine server instances that can be instantly assigned to a user upon request. With reference to FIG. 3, a first virtual machine instance 301, a second virtual machine instance 302, and a sixth virtual machine instance 311 are configured to form a first virtual machine pool 321. Likewise, a third virtual machine instance 303, a fourth virtual machine instance 304, a fifth virtual machine instance 305, a seventh virtual machine instance 312, and an eighth virtual machine instance 313 are configured to form a second virtual machine pool 322.

The first and second virtual machine pools 321 and 322 are controlled, governed, and maintained by a single pool manager 306. The pool manager 306 reduces or eliminates a time to deployment when creating a new virtual machine instance in a cloud. Full-sized, ready to deploy virtual machine instances are created and placed into a pool with other virtual machine instances of the same or similar specifications. For example, all of the virtual machine instances in the first virtual machine pool 321, including the first virtual machine instance 301, the second virtual machine instance 302, and the sixth virtual machine instance 311, are full-sized and ready to deploy. Moreover, all of the virtual machine instances in the first virtual machine pool 321 have identical or similar specifications.

The pool manager 306 analyzes collected historical usage information, including historical virtual machine deployment data, to dynamically decide where, when, and how many of each type of virtual machine instances to place into a pool, such as the first virtual machine pool 321 or the second virtual machine pool 322. This technique provides the advantages of using limited resources while, at the same time, providing full-sized virtual machine instances that require no boot-up, starting, or set-up time.

By keeping historical records of what types of virtual machine instances were created, and when these instances were created, the pool manager 306 can make intelligent decisions regarding how many of each type of virtual machine instance needs to be newly created, what pool the newly created virtual machine instance needs to be placed into, and at what time or times the newly created virtual machine is needed the most. The intelligent virtual machine instance allocation performed by the pool manager 306 allows pools of virtual machine instances to better react and respond to fluctuations in instance creation patterns, and also to not overuse cloud resources by creating too many instances. For example, for a given cloud service, if a favorite machine of a typical user is a medium-sized instance running a Ubuntu™ 14.04×64 operating system, perhaps a greater number of virtual machine instances should be created and placed into a pool type that corresponds to the medium-sized instance running the Ubuntu™ operating system.

The historical usage information analyzed by the pool manager 306 may include information identifying one or more of a time of day, a day of the week, or a day of the year. This time and day information enables recognition of temporal patterns in instance requests received from users. That is, the pool manager 306 is able to discern that, from 11:00 PM to 4:00 AM in a given geographical region, significantly fewer user requests are received relative to other times of day. The pool manager 306 is then able to decide that it is better to reduce power consumption from the electric utility provider by having only two virtual machine instances in a given pool, versus having twelve virtual machine instances in the same pool during peak usage hours. The analysis of historical usage information, including analyzing previous user requests, is not just limited to size and image type for the virtual machine instances, but may also include networking preferences and volume attachment choices. These factors may also be taken into account to ensure little or no configuration would be required at deployment time.

The approaches described in connection with FIGS. 1-3 bypass the time required for instance creation and booting up when a user request is received. This bypassing greatly reduces the overall time required for deployment, and effectively moves the initial deployment and start-up costs to a less critical time prior to a user request being received. This pre-deployment process creates an unparalleled user cloud server experience. Speed is of the essence.

Some embodiments of the present invention may include one, or more, of the following characteristics, operations, features and/or advantages: (i) receiving a multiple pool data set, with the multiple pool data set including a first definition specifying the configuration of a plurality of virtual machine (VM) pools with each VM pool including a set of VM(s), with each VM being respectively characterized by a plurality of attribute values including, at least, a first processing related attribute value (for example, a number of cores) and a first memory attribute value (for example, a random access memory capacity); (ii) receiving an historic usage data set including historical usage information indicative of the way in which the plurality of VM pools has been historically utilized by users; (iii) determining a second definition specifying a configuration for the plurality of VM pools, based at least in part upon the historic usage information, wherein the first definition of VM pools is different than the second definition of VM pools; (iv) configuring an instance of the plurality of VM pools according to the first definition; (v) reconfiguring the instance of the plurality of VM pools configured according to the first definition into an instance of the plurality of VM pools configured according to the second definition; and/or (vi) the difference(s) between the first and second definitions reflect at least one of the following types of differences: (a) moving a VM related resource from a first VM pool of the plurality of VM pools to a second VM pool of the plurality of VM pools, (b) adding a VM pool to the plurality of VM pools, (c) removing a VM pool from the plurality of VM pools, (d) adding a VM related resource to a VM pool of the plurality of VM pools, and/or (e) removing a VM related resource from the plurality of VM pools.

Some embodiments of the present invention may include one, or more, of the following features, characteristics, advantages and/or operations: (i) coordinated management of multiple pools (as opposed to a single pool); (ii) VM instances in a pool are restricted by the size and trade-offs of that pool; (iii) dynamically changing the size and number of pools; (iv) using VM initialization time in the decision; (v) VMs which can be initialized quickly, even though they are high use, will be allocated a smaller pool (for example, containers, which are almost instantaneous, would be assigned no-entry pools); (vi) historic data is used to control pool sizes (for example, when the VM ‘type’ goes into a time period of low use, the pool size is reduced, and just before historic high use, the pool size is increased); (vii) coordination across multiple clouds; (viii) multiple clouds can also be managed by allowing more than one instance of a VM ‘type’ pool as long as it is not co-located; (ix) coordination with upgrade process; and/or (x) especially with containers, when V1 is being replaced by V2, the existing pool for the VM ‘type’ would be identified for V1 and a 2nd pool created for V2—as the migration completes, the allocation to the pools would move from V1 to V2.

Some embodiments of the present invention may include one, or more, of the following features, characteristics, advantages and/or operations: (i) utilizes pools of VMs; (ii) allocates without regard to utilization of computing resources in the VMs; (ii) user selects an amount of CPU cores and RAM at request time; (iii) the use case of a multiple pool system is typically completely different than a use case of a single pool system; (iv) configures a single pool of VMs with a pool manager as described above; (v) working with multiple pools, more work is required from the pool manager which additional work cannot be accommodated by convention methods of pre-allocating pool(s) of VMs; (vi) individually manages each pool, of multiple pools, by a pool manager; (vii) historical data analyzed on a per pool basis and compared against all pools to determine where the allocation needs are; and/or (ix) trade-offs are made between the pools to decide which VM configuration/flavor is more popular and likely to be requested at a particular time.

With regard to typical use cases for multiple pool systems and single pool systems, a single pool system has to optimize the entire pool all the time, whereas a multiple pool system can perform two levels of optimization: (i) a global optimization into pools, and (ii) and local optimization within those pools. The global optimization can be checked independently of the local optimization and can be performed at a different interval. For any pool system, when an entry is used (removed), the pool has to determine what should be added. A pool manager has to look at what is presently in the pool and what that pool covers to determine whether or not any elements or instances should be replaced, or whether nothing needs to be done. Periodically, the pool manager has to review what is in the pool to determine if the pool contains the right elements. With a single pool, the pool manager is doing this for ALL possible entries in the pool. The complexity increases as the number of different instance types in the pool increases. The multiple pool system, by allocating into multiple single pools, performs a global optimization to determine which pools it should contain and then lets each of those pools act as single pools within their assigned area. Thus, instead of one pool with 50 possibilities, one may have 5 pools each with 10 possibilities. Thus, these multiple pools can more quickly determine what to do on removal and separately, independently, the global allocation can be reviewed and updated periodically.

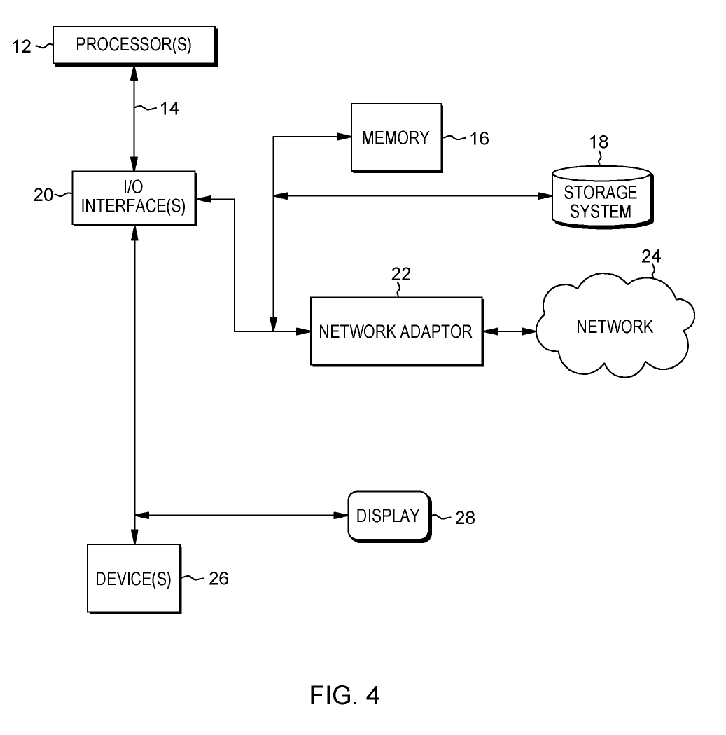

FIG. 4 illustrates an exemplary apparatus on which any of the methods of FIG. 1 or FIG. 2 may be performed in accordance with one or more embodiments of the present invention. This computer system is only one example of a suitable processing system and is not intended to suggest any limitation as to the scope of use or functionality of embodiments of the methodology described herein. The processing system shown may be operational with numerous other general-purpose or special-purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, neural networks, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of the computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
monitoring a plurality of virtual machines that are operating within a cloud, to generate an input data set based on the operating of the plurality of virtual machines;
analyzing, by a machine logic-based pool manager, the input data set to determine configuration data for allocating each respective virtual machine of the plurality of virtual machines to a corresponding pool of a plurality of pools; and
allocating and configuring, by the pool manager, the plurality of virtual machines into the plurality of pools according to the determined configuration data.

2. The computer-implemented method of claim 1 further comprising the pool manager receiving a request to deploy a virtual machine of the plurality of virtual machines in the cloud, wherein the request includes a set of request parameter data.

3. The computer-implemented method of claim 2 further comprising, responsive to the request, the pool manager selecting a pooled virtual machine from any of the plurality of pools, wherein the pooled virtual machine meets the set of request parameter data.

4. The computer-implemented method of claim 3 further comprising the pool manager deploying the pooled virtual machine to fulfill the request.

5. The computer-implemented method of claim 1 wherein the monitoring includes collecting any of the following types of input data: a user identifier, an image type, an identifier for a central processing unit (CPU) core, an amount of random-access memory (RAM) being used, a calendar date, a time, and a duration of initialization for each of the plurality of virtual machines.

6. The computer-implemented method of claim 1 wherein the determination of the configuration data is performed such that the plurality of pools has a highest or maximized probability of meeting a subsequently received set of request parameter data.

7. The computer-implemented method of claim 1 further comprising configuring one or more individual pools of the plurality of pools for a specific set of instance types in terms of image type and resource size.

8. A computer-implemented method comprising:
receiving a multiple pool data set including a first definition that, for each of a respective plurality of virtual machine pools, specifies a corresponding first configuration, wherein each of the respective plurality of virtual machine pools includes a corresponding set of virtual machines, and wherein each virtual machine of each corresponding set of virtual machines is respectively characterized by a plurality of attribute values including at least one of a processing related attribute value, or a memory attribute value, or both a processing related attribute value and a memory attribute value;
receiving an historic data usage set that includes historical usage information indicative of a manner in which the plurality of virtual machine pools has been historically utilized by one or more users;
determining a second definition specifying a corresponding second configuration for each of the respective plurality of virtual machine pools, wherein the second definition is based at least in part on the historical usage information, and wherein the first definition is different from the second definition.

9. The computer-implemented method of claim 8 further comprising configuring an instance of the plurality of virtual machine pools according to the first definition.

10. The computer-implemented method of claim 9 further comprising reconfiguring the instance of the plurality of virtual machine pools according to the second definition.

11. The computer-implemented method of claim 10 wherein the first definition is different from the second definition based on any of:
moving a virtual machine-related resource from a first virtual machine pool of the plurality of virtual machine pools to a second virtual machine pool of the plurality of virtual machine pools;
adding a virtual machine pool to the plurality of virtual machine pools;
removing a virtual machine pool from the plurality of virtual machine pools;
adding a virtual machine related resource to a virtual machine pool of the plurality of virtual machine pools; or
removing a virtual machine related resource from the plurality of virtual machine pools.

12. The computer-implemented method of claim 8 wherein the determining of the second definition specifying the corresponding second configuration for each of the respective plurality of virtual machine pools is performed using a look-up table, and wherein the look-up table associates each virtual machine of each corresponding set of virtual machines with a respective set of instance types.

13. The computer-implemented method of claim 8 further comprising determining a current stock of virtual machines in each pool of the respective plurality of virtual machine pools, and locating a specific virtual machine that will be deployed in response to one or more subsequently received requests that are predicted to be received from a user based upon the historical usage information.

14. A computer program product comprising a computer-readable storage medium having a computer-readable program stored therein, wherein the computer-readable program, when executed on a computing device including at least one processor, causes the at least one processor to:
monitor a plurality of virtual machines that are operating within a cloud, to generate an input data set based on the operating of the plurality of virtual machines;
analyze, by a machine logic-based pool manager, the input data set to determine configuration data for allocating each respective virtual machine of the plurality of virtual machines to a corresponding pool of a plurality of pools; and
allocate and configure, by the pool manager, the plurality of virtual machines into the plurality of pools according to the determined configuration data.

15. The computer program product of claim 14 further configured for the pool manager receiving a request to deploy a virtual machine of the plurality of virtual machines in the cloud, wherein the request includes a set of request parameter data.

16. The computer program product of claim 15 further configured for the pool manager selecting a pooled virtual machine from any of the plurality of pools in response to the request, wherein the pooled virtual machine meets the set of request parameter data.

17. The computer program product of claim 16 further configured for causing the pool manager to deploy the pooled virtual machine to fulfill the request.

18. The computer program product of claim 14 wherein the monitoring is further configured for collecting any of the following types of input data: a user identifier, an image type, an identifier for a central processing unit (CPU) core, an amount of random-access memory (RAM) being used, a calendar date, a time, and a duration of initialization for each of the plurality of virtual machines.

19. The computer program product of claim 14 wherein the determination of the configuration data is performed such that the plurality of pools has a highest or maximized probability of meeting a subsequently received set of request parameter data.

20. The computer program product of claim 14 wherein one or more individual pools of the plurality of pools are configured for a specific set of instance types in terms of image type and resource size.
